(19) United States
(12) Patent Application Publication
(10) Pub. No.: US 2017/0098265 A1
(43) Pub. Date: Apr. 6, 2017

(54) INFORMATION PROVIDING SYSTEM, MAIN SERVER AND INFORMATION PROVIDING METHOD FOR PROVIDING ENTERTAINMENT SERVICE INFORMATION

(71) Applicant: Zoek Inc., Taipei City (TW)

(72) Inventors: Ting-Kuan CHEN, Taipei City (TW); Chun-Ju YU, Taipei City (TW)

(21) Appl. No.: 15/275,485

(22) Filed: Sep. 26, 2016

(30) Foreign Application Priority Data
Oct. 1, 2015 (TW) 104215757

(51) Int. Cl. G06Q 30/06; G06Q 30/02

(52) U.S. Cl. CPC G06Q 30/0623; G06Q 30/0282; H04L 67/42

(57) ABSTRACT

An information providing system for providing entertainment service information includes a main server and an electronic device. The electronic device is configured to be connected to the main server and to provide location information and consumer information to the main server. The main server is configured to provide a plurality of product classification information to the electronic device according to the location information, the consumer information and a plurality of product information. The electronic device is configured to provide selected product clarification information to the main server. The main server is configured to provide low-priced product information or highly-rated product information to the electronic device according to the selected product classification information, for a consumer making selection. The low-priced product information or the highly-rated product information corresponds to at least one entertainment service.

### RELATED APPLICATIONS

This application claims priority to Taiwan Application Serial Number 104215757, filed Oct. 1, 2015, which is herein incorporated by reference.

### BACKGROUND

Technical Field

The present disclosure relates to an information providing system, main server, and information providing method for providing entertainment service information.

Description of Related Art

With the rapid development of the technology and the promotion of quality of life, people pay great attention to the aspects of leisure, entertainment, beauty, or social activities. If a consumer wants to go to a restaurant to eat food, the consumer needs to call the restaurant to make a reservation. However, when the consumer decides the restaurant and dinning time and calls the restaurant, it is possible that the tables of the restaurant are fully reserved. Good quality restaurants are very popular. When the tables of the restaurant are fully reserved, the consumer needs to spend a significant amount of time finding another suitable restaurant or change the dinning time.

### SUMMARY

One embodiment of the present disclosure is related to an information providing system for providing entertainment service information. The information providing system includes a main server and an electronic device. The electronic device is configured to be connected to the main server and to provide location information and consumer information to the main server. The main server is configured to provide a plurality of product classification information to the electronic device according to the location information, the consumer information and a plurality of product information. The electronic device is configured to provide selected product classification information to the main server. The main server is configured to provide low-priced product information or highly-rated product information to the electronic device according to the selected product classification information, for a consumer making selection. The low-priced product information or the highly-rated product information corresponds to at least one entertainment service.

One embodiment of the present disclosure is related to a main server. The main server is applied in an information providing system for providing entertainment service information. The main server includes a first interface, a second interface, a storing circuit, a calculating circuit, and a register. The first interface is configured to receive location information and consumer information. The second interface is configured to receive a plurality of product information. The storing circuit is configured to store the location information, the consumer information, and the plurality of product information. The calculating circuit is coupled to the first interface, the second interface, and the storing circuit. The calculating circuit is configured to provide a plurality of product classification information according to the location information, the consumer information, and the plurality of product information. The calculating circuit is further configured to generate low-priced product information or highly-rated product information according to selected product classification information. The register is coupled to the calculating circuit. The register is configured to store the product classification information. The first interface is configured to provide the low-priced product information or the highly-rated product information to an electronic device. The low-priced product information or the highly-rated product information corresponds to at least one entertainment service.

One embodiment of the present disclosure is related to an information providing method for providing entertainment service information. The information providing method includes: receiving location information, consumer information, and product information; providing product classification information according to the location information; receiving selected product classification information; and providing low-priced product information or the highly-rated product information according to the selected product classification information for a consumer making selection. The low-priced product information or the highly-rated product information corresponds to at least one entertainment service.

As the above embodiments, the low-priced product information or the highly-rated product information provided by the information providing system of the present disclosure and the main server of the present disclosure is generated according to a location of a consumer, relevant information of the consumer, and product information from a store. Thus, the low-priced product information or the highly-rated product information is closely matched to the demand of the consumer. In addition, the consumer only acquires the product information of products that haven't been reserved yet. Thus, the consumer doesn't need to spend much time finding a store or a restaurant, making sure available time, the price of the product, and reserving the product or the table. In addition, in some embodiments, a product corresponding to the low-priced product information is the product with lowest price in the corresponding time, and a product corresponding to the highly-rated product information is the product with high rating in the corresponding time. Thus, the consumer doesn't need to compare a plurality of products in the corresponding time by their own.

It is to be understood that both the foregoing general description and the following detailed description are examples, intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1A-1B is a schematic diagram illustrating an information providing system for providing entertainment service information according to one embodiment of the present disclosure;

FIG. 2 is a schematic diagram illustrating a product selection interface is displayed on an electronic device according to one embodiment of the present disclosure;

FIG. 3A-3C is a schematic diagram illustrating a main server in FIG. 1A or FIG. 1B according to one embodiment of the present disclosure;

FIG. 4A-4B is a schematic diagram illustrating a main server according to another embodiment of the present disclosure; and

FIG. 5 is a flow diagram illustrating an information providing method for providing entertainment service information according to one embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts. The embodiments below are described in detail with the accompanying drawings but the examples provided are not intended to limit the scope of the disclosure covered by the description. The structure and operation are not intended to limit the execution order. Any structure regrouped by elements, which has an equal effect, is covered by the scope of the present disclosure.

Moreover, the drawings are for the purpose of illustration only, and are not in accordance with the size of the original drawing. The components in description are described with the same number to understand.

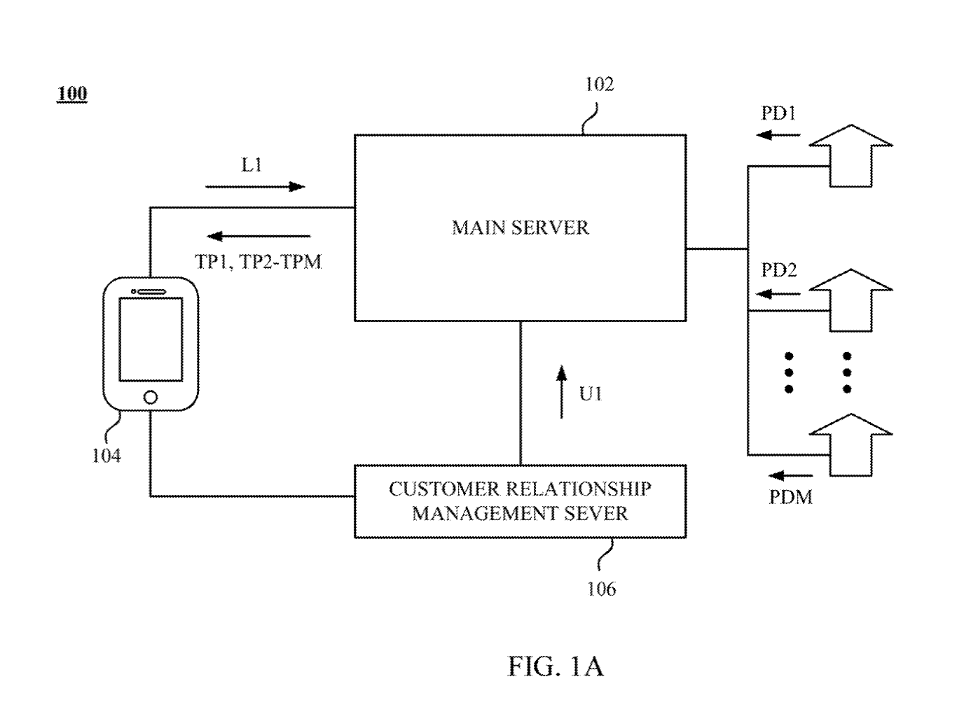

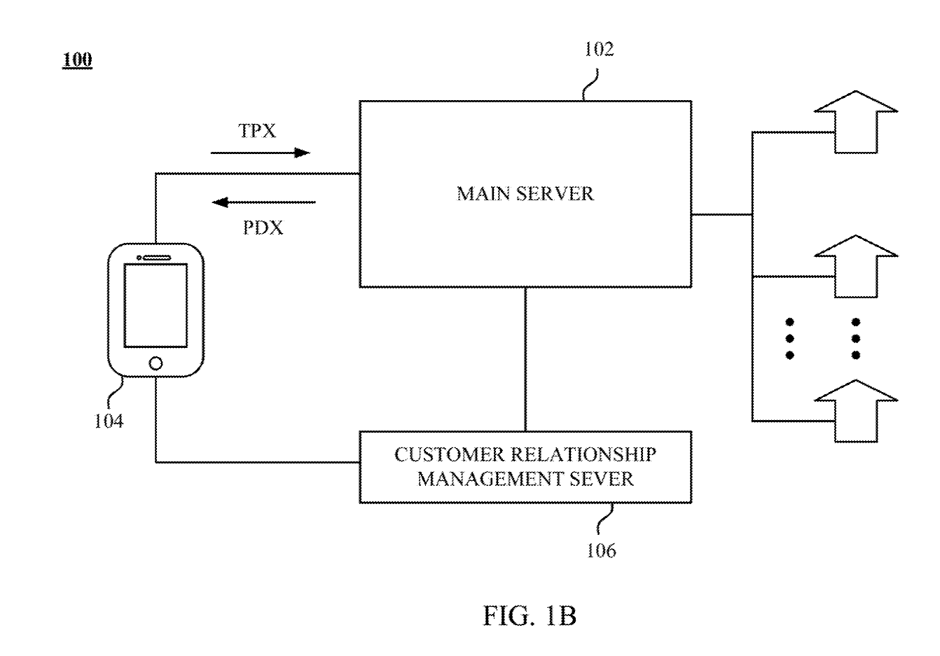

FIG. 1A-1B is a schematic diagram illustrating an information providing system 100 for providing entertainment service information according to one embodiment of the present disclosure. As illustrated in FIG. 1A and in FIG. 1B, the information providing system 100 includes a main server 102 and an electronic device 104. The electronic device 104 includes a personal computer (PC), a tablet, a personal digital assistant (PDA), a smart phone a notebook (such as, an ultrabook), a wearable smart device (such as, a smart watch), a smart intelligent appliance, or other electronic devices. The electronic device 104 is for example, a smart phone, but is not limited thereto.

The electronic device 104 is configured to connect to the main server 102. In some embodiments, a consumer may register an user account in advance and log in the user account by operating the electronic device 104, such that the electronic device 104 is connected to the main server 102 through the Internet.

When the electronic device 104 logs in the aforementioned user account, the electronic device 104 may provide location information L1 to the main server 102. In some embodiments, the electronic device 104 may include a locating module. The electronic device 104 provides the location information L1 to the main server 102 by the locating module. The locating module is, for example, a global positioning system (GPS). The location information L1 includes the longitude and latitude where the electronic device 104 is or an administrative region where the electronic device 104 is.

When the electronic device 104 logs in the aforementioned user account, the main server 102 may receive consumer information U1. In some embodiments, the information providing system 100 may further include customer relationship management (CRM) server 106. When the electronic device 104 logs in the aforementioned user account the electronic device 104 may transmit relevant information of the user account to the CRM server 106. The CRM server 106 may utilize algorithm to analyze and calculate the relevant information (such as, weighting calculation) to obtain the consumer information U1. Then, the consumer information U1 is transmitted to the main server 102 to be calculated. In some embodiments, the CRM server 106 and the main server 102 may be integrated into a server device. However, if the electronic device 104 doesn't log in the aforementioned user account, the main server 102 is merely able to receive the location information L1 and utilize the location information L1 to perform calculation. By this way, the information providing system 100 may provide the consumer a service similar to “trial.”

The consumer information U1 may include historic habit information of the consumer or individual data of the consumer. The historic habit information of the consumer may represent that whether the consumer often buy or look up a kind of product during a past time or not. For example, if a consumer often looks up a hot spring hotel during the past time it represents that the consumer has demand of accommodation and the consumer prefers hot spring hotel. For example, if a consumer often looks up a nail treatment store during a past time, it represents that the consumer has a demand of nail treatment. The individual data of the consumer represents the gender of the consumer, age of the consumer, hobbies of the consumer, career of the consumer, or revenue of a year of the consumer. When the consumer registers the aforementioned user account, the consumer is requested to fill in the individual data of the consumer. The individual data of the consumer is recorded. In some embodiments, the CRM server 106 may also receive transaction information from the electronic device 104. The transaction information is, for example, a trade record during a past time of the electronic device 104.

In addition, except for the location information L1 and the consumer information U1, the main server 102 also receives product information PD1, PD2-PDM. The product information PD1, PD2-PDM may be transmitted from electronic devices of stores to the main server 102. Each of the product information PD1, PD2-PDM may include a location of a store, an entertainment service provide by the store, an amount corresponding to the entertainment service, a time interval corresponding to the entertainment service, and a price corresponding to the entertainment service. Specially, “time interval” represents a time duration in which the product is able to be reserved.

In some embodiments, the entertainment services may correspond to different product provided by a store in a same time interval. In some embodiments, the entertainment services may correspond to a same product provided by a store in different time intervals. In some embodiment, the entertainment services may correspond to different product provided by a store in different time interval.

For example, the product information PD1 may correspond to “a commercial hotel A in Datong district, junior room, 10:00 am-2:00 pm, 15, September, $16,” the product information PD2 may correspond to “a motel B in Datong district, VIP room, 10:15 am-01:15 pm, 15, September, $32,” and the product information PDM may correspond to “a massage store C, massager D, body massage (one hour or two hours)/neck and shoulder massage (half of an hour or one hour)/foot massage (half of an hour or one hour), 11:00 am-01:00 pm, 15, September, $30 or $60/$15 or $30/$15 or $30.”

The stores may set the price. Although the aforementioned prices are fixed prices. In some other embodiments, the prices may be floating prices. The floating price may be a real time average price, a real time highest price or a real time lowest price. For example, if a store sets a price of an entertainment service as a real time lowest price, the price of the entertainment service is same as a price of a product with lowest price among a plurality of products in same product classification and in same time interval. Alternatively, in some other embodiments, if a store sets a price of an entertainment service as a real time lowest price, the price of the entertainment service is lower than a price of a product with lowest price among a plurality of products in same product classification and in same time interval. The price difference may be set by the store. Under this condition, the entertainment service has advantages in price.

The main server 102 may classify the product information PD1, PD2-PDM. For example, the product information PD1 and the product information PD2 are classified into a same product classification, such as a rest classification. The product information PDM is classified to another product classification, such as massage classification.

Except for the rest classification and the massage classification; the product classification may include a movie theater classification, a hotel classification, a restaurant classification, a nail treatment classification, an amusement park classification, an exhibition classification, an entertainment classification, a sport and fitness classification, a tour guide classification, cosmetics classification, a class classification, a karaoke classification, or other classifications. In some embodiments, the aforementioned classifications may be further classified. For example, the massage classification may be further classified into a neck and shoulder classification, foot classification, head classification, and so on.

Then, the main server 102 performs calculation according to the location information L1, the consumer information U1, and the product information PD1, PD2-PDM to generate a plurality of product classification information TP1, TP2-TPM. The main server 102 transmits the product classification information TP1, TP2-TPM to the electronic device 104. For example, if the location information L1 represent that the consumer is at Datong district and if the consumer information U1 represents that the consumer often looks up information about massage and rest during a past time interval, a plurality of product classifications which are matched to the consumer, such as a massage classification and a stay by hour classification, are selected by the main server 102. The main server 102 transmits the product classification information TP1, TP2-TPM corresponding to the product classification to the electronic device 104 for the consumer making selection. At the same time, the main server 102 also utilizes a way of mapping to generate a list. The main server 102 selects an entertainment service with a lowest price in each of time intervals from the list to generate a low-priced product information PDX. The low-priced product information PD is stored in the main server 102.

Since the product classification information TP1, TP2-TPM is generated according to the location information L1 and the consumer information U1, the product classification information TP1, TP2-TPM is more satisfied to the demand of the consumer, and the consumer may save traffic time.

Then, as illustrated in FIG. 1B, the consumer may select one of the product classifications as a selected product classification by operating the electronic device 104. For example, if the consumer selects the massage classification, the massage classification is the selected product classification. The electronic device 104 may transmit the selected product classification information TPX corresponding to the selected product classification to the main server 102. Then, the main server 102 provides the low-priced product information PDX according to the selected product classification information TPX.

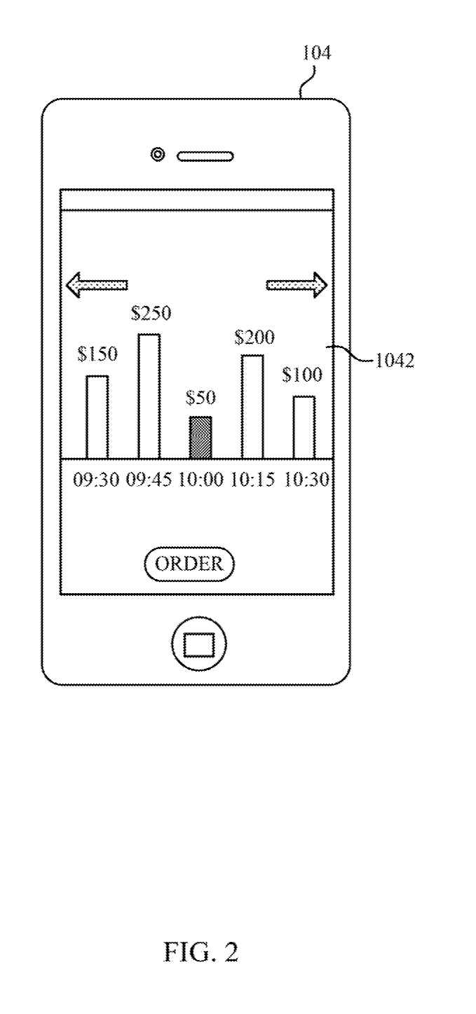

The low-priced product information PDX is transmitted to the electronic device 104. Reference is made to FIG. 2. FIG. 2 is a schematic diagram illustrating a product selection interface 1042 is displayed on an electronic device 104 according to one embodiment of the present disclosure. When the electronic device 104 receives the low-priced product information PDX, the electronic device 104 displays the product selection interface 1042 on a display screen of the electronic device 104 according to the low-priced product information PDX. The product selection interface 1042 includes a plurality of prices and a time sequence having a plurality of time options. The prices correspond to the time options respectively. Each of the prices corresponds to a price of a product with lowest price in the corresponding time option. In other words, the price of the entertainment service with the lowest price selected by the main server 102 and the corresponding time interval are displayed on the product selection interface 1042. Thus, the consumer doesn't need to compare the prices of different entertainment services in different time intervals. The entertainment services displayed on the product selection interface 1042 may be provided by one store or a plurality of stores.

In some embodiments, one of the time options of the product selection interface 1042 is a default order option. As illustrated in FIG. 2, the time option in the middle is the default order option. If the consumer wants to look or select other time options, the consumer may change the time sequence bar by sliding their finger horizontally right or left on the touch screen. However, no matter the consumer action, the time option in the middle is always the default order selection. At this time, if the consumer triggers the “order” button, it represents that the consumer wants to order the entertainment service corresponding to the middle time option. Then, the system enters into a next interface to perform following order procedure or notify the consumer the relevant information of the entertainment service (such as, address of the store, electronic map of the store, or the telephone of the store). In some embodiments, the relevant information of the entertainment service may be displayed on the product selection interface 1042 simultaneously. In addition, the time difference between two adjacent time options is 15 minutes in FIG. 2, but is not limited thereto.

In some embodiments, the product information PD1, PD2-PDM may be updated by the stores at any time. For example, if the entertainment service corresponding to the product information PD1 is ordered by other people through other approach, the store which provides the product information PD1 may update the product information PD1 in real time. Thus, the probability that the entertainment service are ordered by two consumers may be reduced accordingly.

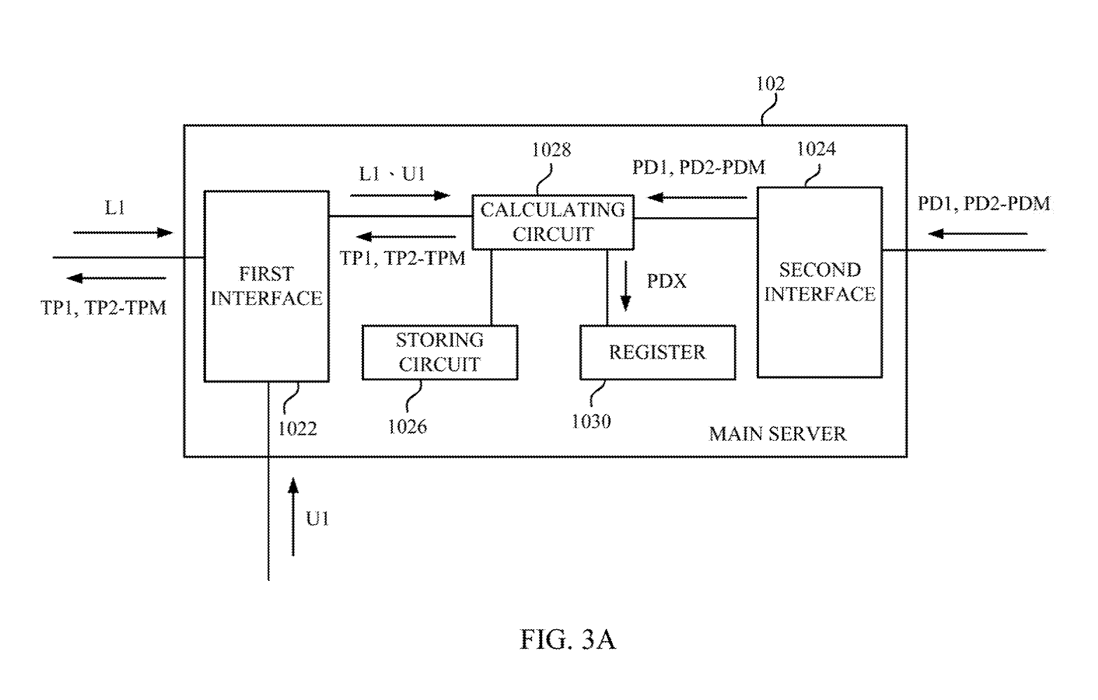

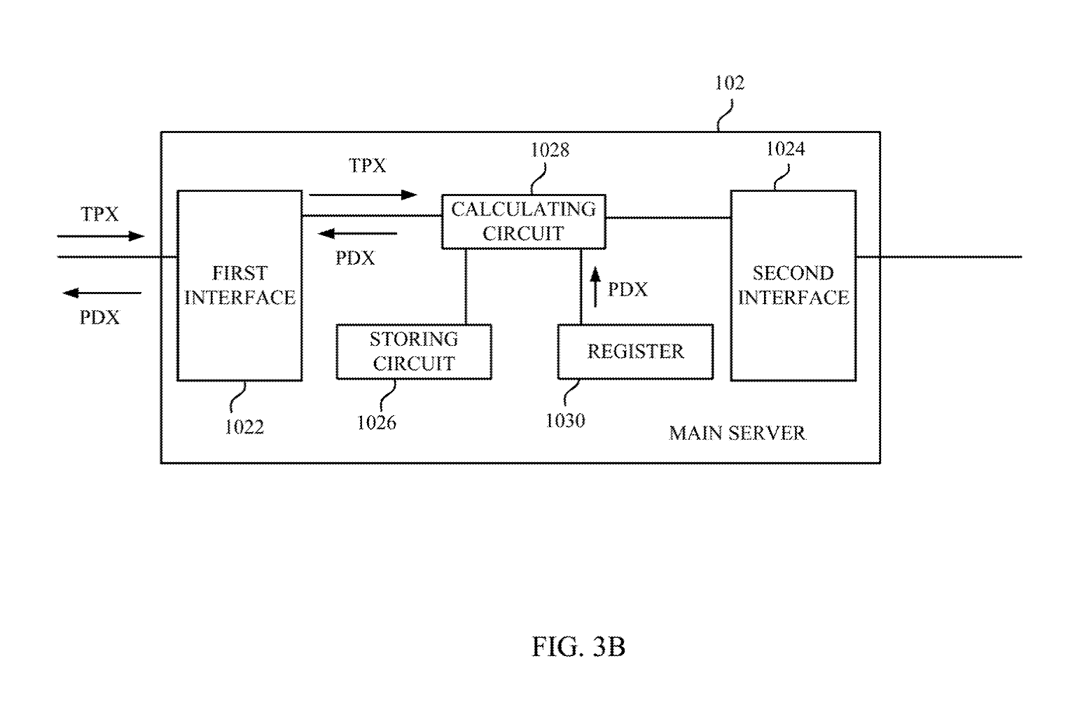

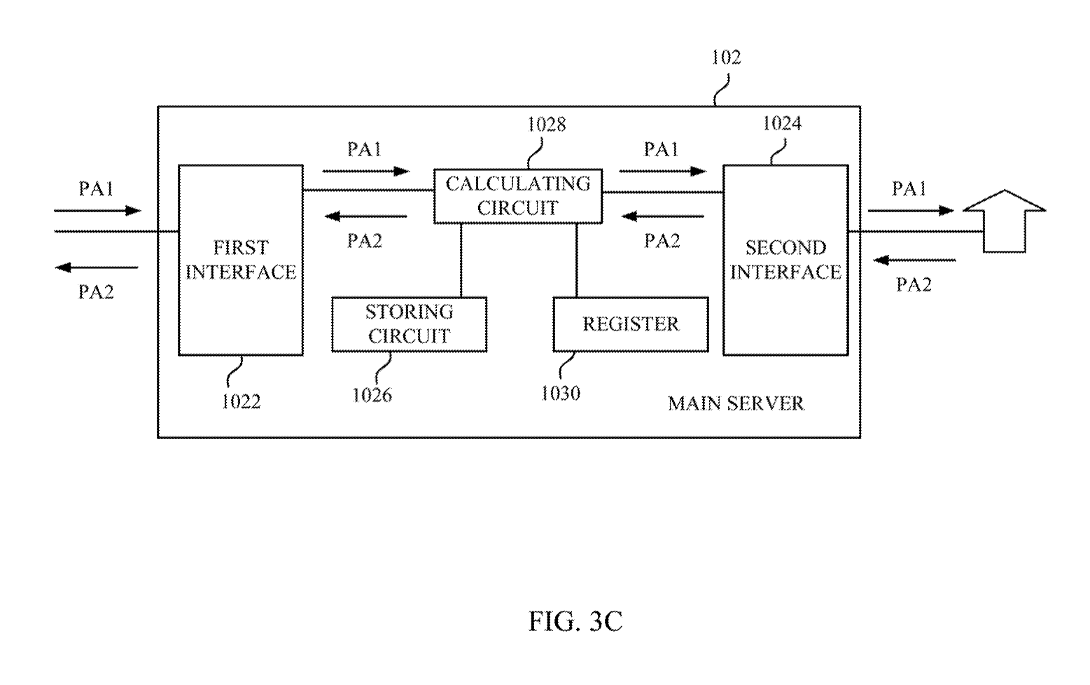

FIG. 3A-3C is a schematic diagram illustrating the main server 102 in FIG. 1A or FIG. 1B according to one embodiment of the present disclosure. As illustrated in FIG. 3A, the main server 102 includes a first interface 1022, a second interface 1024, a storing circuit 1026, a calculating circuit 1028, and a register 1030.

The calculating circuit 1028 is coupled to the first interface 1022, the second interface 1024, the storing circuit 1026, and the register 1030. In some embodiments, the first interface 1022 and the second interface 1024 are, for example, an application programming interface (API).

The first interface 1022 is configured to receive the location information L1 from the electronic device 104 and the consumer information U1 from the CRM server 106. The first interface 1022 is configured to transmit the location information L1 and the consumer information U1 to the calculating circuit 1028. The location information L1 and the consumer information U1 are stored in the storing circuit 1026. The second interface 1024 is configured to receive the product information PD1, PD2-PDM from at least one store. The second interface 1024 is further configured to transmit the product information PD1, PD2-PDM to the calculating circuit 1028. The product information PD1, PD2-PDM are stored in the storing circuit 1026. Then, the calculating circuit 1028 storing service code calculates the location information L1, the consumer information U1, and the product information PD1, PD2-PDM, to generate a plurality of product classification information TP1, TP2-TPM. The product classification information TP1, TP2-TPM are transmitted to the electronic device 104 through the first interface 1022. At the same time, the calculating circuit 1028 generates the aforementioned list, to generate the low-priced product information PDX. The list and the low-priced product information PDX are stored in the register 1030.

Then, as illustrated in FIG. 3B, the consumer selects one of the product classification information TP1, TP2-TPM as the selected product classification information TPX by operating the electronic device 104. The low-priced product information PDX stored temporarily in the register 1030 may be provided according to the selected product classification information TPX to the electronic device 104 through the first interface 1022, such that the electronic device 104 displays the product selection interlace 1042 as illustrated in FIG. 2 on the display screen of the electronic device 104. As illustrated in FIG. 3C, when the consumer orders a specific entertainment service through the product selection interface 1042 in FIG. 2, the electronic device 104 sends order notification information PA1. The first interface 1022 of the main server 102 is configured to receive the order notification information PA1. Then, the calculating circuit 1028 is configured to transmit the order notification information PA1 to a corresponding store through the second interface 1024. Under this condition, the store may send order identification information PA2. The order identification information PA2 may include a mail, a message, a word string, an electronic ticket, or QRcode. The second interface 1024 is configured to receive the order identification information PA2. Then, the calculating circuit 1028 is configured to transmit the order identification information PA2 to the electronic device 104 through the first interface 1022.

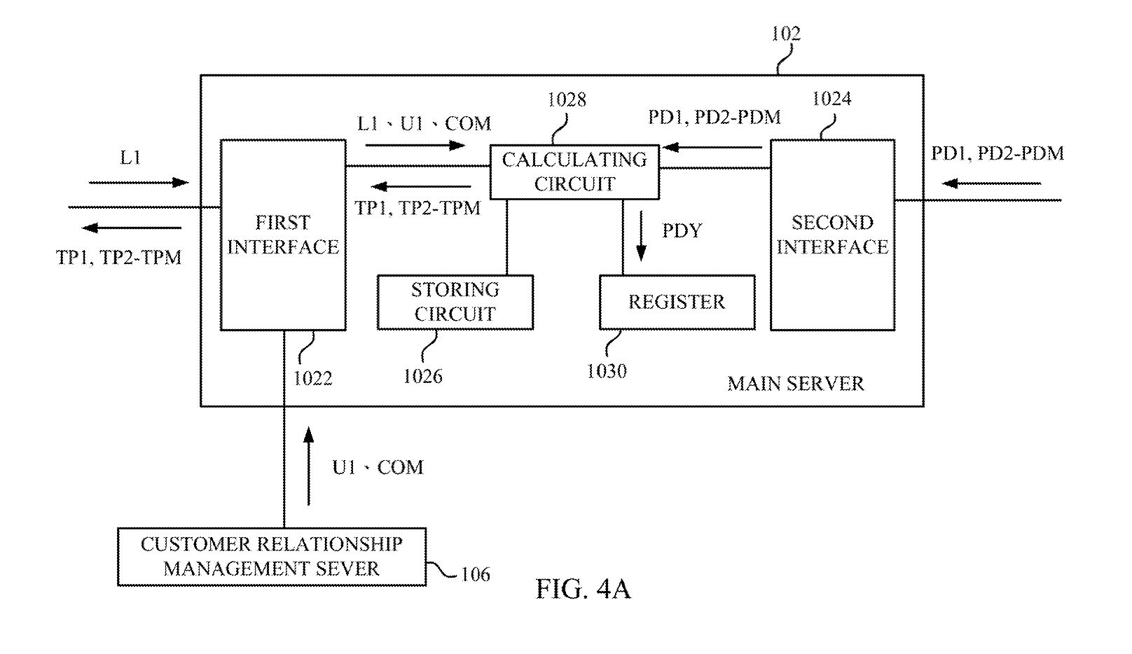

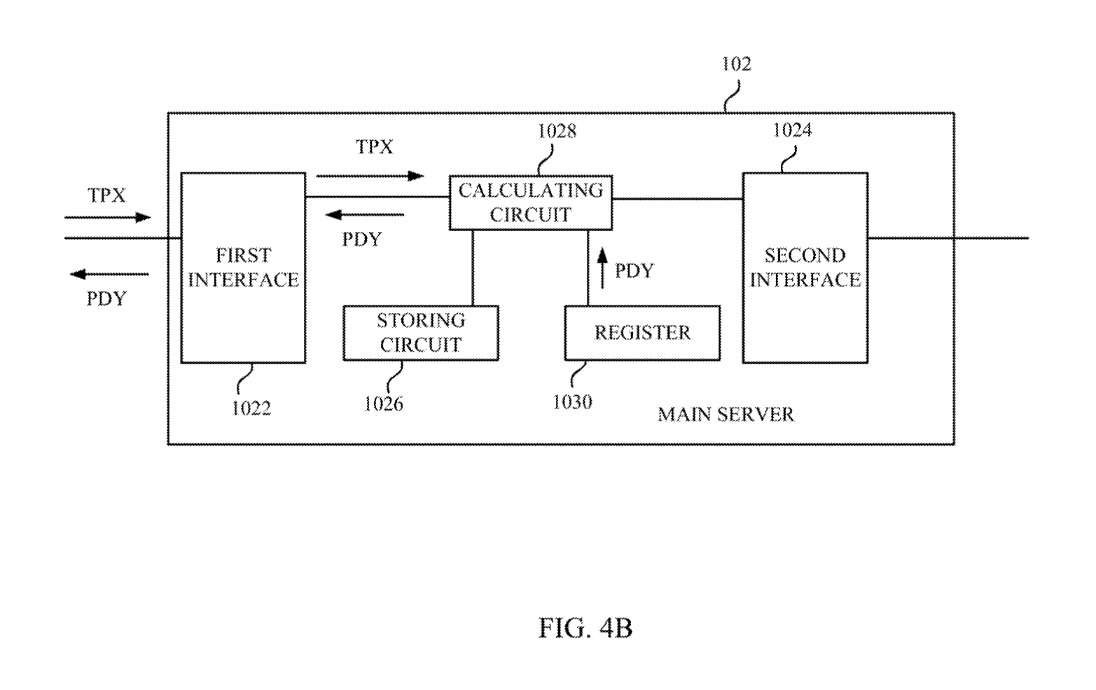

FIG. 4A-4B is a schematic diagram illustrating a main server 102 according to another embodiment of the present disclosure. The difference between the embodiment in FIG. 3A and FIG. 3B and the embodiment of FIG. 4A and FIG. 4B is that the main server 102 in FIG. 4A and FIG. 4B provides highly-rated product information PDY, rather than low-priced product information PDX.

In some embodiments, the first interface 1022 receives one or more rating information COM. The rating information COM is from the CRM serve 106. The rating information COM is configured to record a rating to a product from at least one consumer. The first interface 1022 is configured to transmit the location information L1, the consumer information U1, and the rating information COM to the calculating circuit 1028. The calculating circuit 1028 perform calculation to the information and the product information PD1, PD2-PD3, to provide the product classification information TP1, TP2-TPM to the electronic device 104. At the same time, the calculating circuit 1028 also generates a list by a way of mapping. The calculating circuit 1028 selects an entertainment service that is highly rated in each of time intervals from the list. The calculating circuit 1028 generates highly-rated product information PDY according to prices of the entertainment services and corresponding time intervals of the entertainment services. As to the low-priced product information PDX, the highly-rated product information PDY also may be stored in the register 1030.

Then, as illustrated in FIG. 4B, the electronic device 104 may transmit the product classification information TPX to the main server 102. Then, the main server 102 may transmit the highly-rated product information PDY stored in the register 1030 to the electronic device 104 through the first interface 1022.

Reference is made to FIG. 2 again. When the electronic device 104 receives the highly-rated product information PDY, the electronic device 104 displays the product selection interface 1042 on the display screen of the electronic device 104. The product selection interface 1042 includes a plurality of prices and a time sequence having a plurality of time options. The prices correspond to the time options respectively. Each of the prices corresponds to a price of a product that has highest rating in the corresponding time option. For example, a price of a product is $50 and is corresponding to 10:00 am of the time sequence. The product may not be a product that has a lowest price in the time interval. The product is a product that has highly rating in the time interval (10:00 am-10:15 am). In some embodiments, the product may be a product that has a lowest price and highly rating in the time interval.

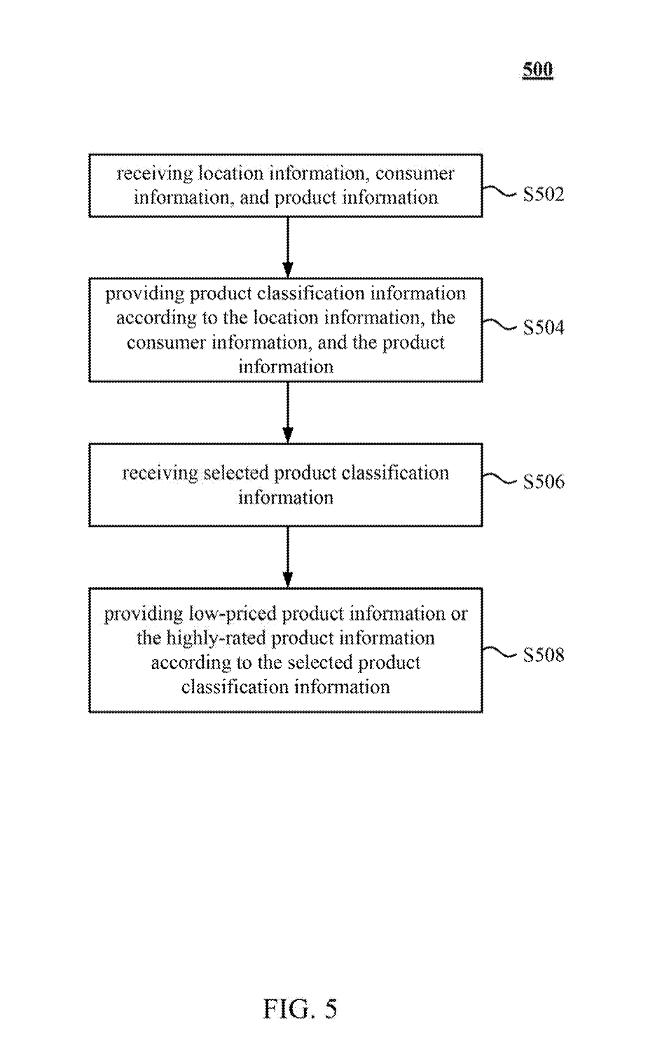

FIG. 5 is a flow diagram illustrating an information providing method 500 for providing entertainment service information according to one embodiment of the present disclosure. As illustrated in FIG. 5, the information providing method 500 includes the steps S502, S504, S3506, and S508.

The step S502 is performed for receiving location information, consumer information, and product information. The step S504 is performed for providing product classification information according to the location information, the consumer information, and the product information. The step S506 is performed for receiving selected product classification information. The step S508 is performed for providing low-priced product information or the highly-rated product information according to the selected product classification information. The detail of the information providing method 500 is provided in aforementioned embodiments so is not repeated again.

As the above embodiments, the low-priced product information or the highly-rated product information provided by the information providing system of the present disclosure and the main server of the present disclosure generated according to a location of a consumer, relevant information of the consumer, and product information from a store. Thus, the low-priced product information or the highly-rated product information is closely matched to the demand of the consumer. In addition, the consumer only acquires the product information of products that haven't been reserved yet. Thus, the consumer doesn't need to spend much time finding a store or a restaurant, making sure available time, the price of the product, and reserving the product or the table. In addition, in some embodiments, a product corresponding to the low-priced product information is the product with lowest price in the corresponding time, and a product corresponding to the highly-rated product information is the product which is highly rated by other consumers in the corresponding time. Thus, the consumer doesn't need to compare a plurality of products in the corresponding time by their own.

Although the present disclosure has been described in considerable detail with reference to certain embodiments thereof, other embodiments are possible. Therefore, the spirit and scope of the appended claims should not be sited to the d ascription of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An information providing system for providing entertainment service information, comprising:
a main server; and
an electronic device configured to be connected to the main server and to provide location information and consumer information to the main server, wherein the main server is configured to provide a plurality of product classification information to the electronic device according to the location information, the consumer information and a plurality of product information, wherein the electronic device is configured to provide selected product classification information to the main server, wherein the main server is configured to provide low-priced product information or highly-rated product information to the electronic device according to the selected product classification information, for a consumer making selection,
wherein the low-priced product information or the highly-rated product information corresponds to at least one entertainment service.

2. The information providing system of claim 1, wherein the consumer information comprises historic habit information of a consumer or individual data of the consumer.

3. The information providing system of claim 1, wherein each of the product information comprises a location of a store, an entertainment service provided by the store, a time interval corresponding to the entertainment service, an amount corresponding to the entertainment service, and a price corresponding to the entertainment service.

4. The information providing system of claim 3, wherein the price comprises a fixed price or a floating price, and the floating price comprises a real time average price, a real time highest price or a real time lowest price.

5. The information providing system of claim 1, wherein the electronic device displays a product selection interface according to the low-priced product information or the highly-rated product information, the product selection interface comprises a plurality of prices and a time sequence having a plurality of time options, the prices corresponds to the time options respectively, each of the prices corresponds to a price of a product with lowest price or a product with highest rating in the corresponding time option, and at least one of the time options is a default order option.

6. The information providing system of claim 1, wherein the product classification information comprises a massage classification, a movie theater classification, a hotel classification, a restaurant classification, a nail treatment classification, a hair salon classification, an amusement park classification, an exhibition classification, an entertainment classification, a sport and fitness classification, a tour guide classification, a cosmetics classification, a class classification, or a karaoke classification.

7. A main server, applied in an information providing system for providing entertainment service information, wherein the main server comprises:
a first interface configured to receive location information and consumer information;
a second interface configured to receive a plurality of product information;
a storing circuit configured to store the location information, the consumer information, and the plurality of product information;
a calculating circuit coupled to the first interface, the second interface, and the storing circuit, wherein the calculating circuit is configured to provide a plurality of product classification information according to the location information, the consumer information, and the plurality of product information, the calculating circuit is further configured to generate low-priced product information or highly-rated product information according to selected product classification information; and
a register coupled to the calculating circuit, wherein the register is configured to store the product classification information,
wherein the first interface is configured to provide the low-priced product information or the highly-rated product information to an electronic device, wherein the low-priced product information or the highly-rated product information corresponds to at least one entertainment service.

8. The main server of claim 7, wherein the first interface is further configured to receive order notification information from the electronic device, and the calculating circuit is further configured to transmit the order notification information to a store corresponding to the order notification information through the second interface.

9. The main server of claim 8, wherein the second interface is further configured to receive order identification information from the store, and the first interface is further configured to provide the order identification information to the electronic device.

10. The main server of claim 7, wherein the low-priced product information or the highly-rated product information is displayed on a product selection interface, the product selection interface comprises a plurality of prices and a time sequence having a plurality of time options, the prices corresponds to the time options respectively, each of the prices corresponds to a price of a product with lowest price or a product with highest rating in the corresponding time option.

11. An information providing method for providing entertainment service information, comprising:
receiving location information, consumer information, and product information;
providing product classification information according to the location information;
receiving selected product classification information; and
providing low-priced product information or the highly-rated product information according to the selected product classification information, for a consumer making selection;
wherein the low-priced product information or the highly-rated product information corresponds to at least one entertainment service.
